(19) United States
(12) Patent Application Publication
(10) Pub. No.: US 2005/0031428 A1
(43) Pub. Date: Feb. 10, 2005

(54) Shearing/milling head device

(76) Inventor: Per Oyvind Bo, Stavanger (NO)

Correspondence Address: MARGER JOHNSON & MCCOLLOM PC, 1030 SW MORRISON STREET, PORTLAND, OR, 97205, US

(21) Appl. No.: 10/481,400

(22) PCT Filed: Jun. 19, 2002
(86) PCT No.: PCT/NO02/00219

(30) Foreign Application Priority Data
Jun. 21, 2001 (NO) 20013083

(51) Int. Cl. B23C 1/00

(52) U.S. Cl. 409/201

(57) ABSTRACT

A cutting/milling head device (1) of the type connected to a cutting machine/milling machine (2), and where the cutting/milling head (1) is designed, when in operation, to be able to change the angle of a cutting tip/the mill (76) relative to a central axis (8a) while at the same time rotating the cutting tip/mill (76) about the same central axis (8a), and where e.g. an axially movable spindle (8) is equipped with at least one toothed rack (68) in engagement with at least two cogwheels (66), where the cogwheels (66) via at least two shafts (62) rotatably mounted to a rotational sleeve (10) are connected to their respective, mutually parallel lower elbow lever (60a) and upper elbow lever (60b), the elbow levers (60a, 60b) at opposite end portions being hinged to a parallel lever (72), and where the lower end portion of the parallel lever (72) is hinged to a cutting tip holder (75), the hinge joints of the parallel lever (72) to the elbow levers (60a, 60b) and the cutting tip holder (75) having parallel axes. A first disc/cogwheel (74) is rigidly mounted via a shaft (70a) to the lower elbow lever (60a), where the shaft (70a) constitutes the hinge joint to the parallel lever (72), and a second disc/cogwheel (78) is rigidly mounted to and the cutting tip holder (75) at the hinge joint to the lower portion of the parallel lever (72), the two discs/cogwheels being interconnected by means of a belt/chain (80), whereby the cutting head (1) is designed so that the direction of cutting of the cutting tip always faces a pivot point (82).

This invention regards a cutting/milling head of the type typically used in a multi-axis cutting machine or milling machine where the direction angle of the cutting tip/mill must be changed during operation.

Multi-axis cutting machines are available for many purposes. In this context, multi-axis refers to the fact that a machine works with more than two guiding axes. Typical applications may be the cutting of metal in the for of sheet metal and pipes or composite materials in the form of cloth or sheets.

The cutting medium used in machines of the type in question may be e.g. acetylene/oxygen gas, plasma, laser or water, all depending on the material to be cut.

For instance, when cutting a steel plate into the desired shape with a welding groove along all or part of the side edges, it is important to be able to advance the cutting tip at a constant speed that is adapted to the cutting medium, also when the direction of cutting is altered quickly, as is the case at the corners of the plate.

In order to maintain the correct cutting angle relative to the finished edge of the workpiece, the cutting tip must be rotated so as to maintain its direction relative to the cutting edge.

When using plasma as the cutting medium to cut 10 mm thick steel plates, it is normal to employ a rate of feed of approximately 3 metres per minute. Therefore, when the cutting tip gets to a corner, it is necessary to switch the direction of the cutting tip in a very short time if a constant cutting speed is to be maintained. If it takes 0,25 seconds to turn the cutting tip through 90° around a corner, the smallest possible obtainable corner radius will be approximately 8 mm.

Cutting heads according to prior art are not able to turn as quickly as described here, and therefore such cutting heads are not suitable for cutting sharp corners when using cutting media that require a constant cutting speed in order to give a good result. Therefore, when using cutting heads according to prior art, the cutting must be halted when the cutting tip reaches a point where a sharp corner is required, whereupon the cutting head is turned and the cutting commences in the new direction.

Cutting heads according to prior art have also proven to be sensitive to metal spray and other contaminants that occur during cutting operations.

Operationally, the same conditions as those described above also apply to mills in a milling machine. For instance, according to prior art, bevelling of a hole requires the use of a mill having a geometry that complementarily shapes the bevel when the rotating mill follows the edge of the hole. By using a device according to the invention, an edge may be bevelled by means of e.g. a cylindrical mill.

The object of the invention is to remedy the disadvantages of prior art.

The object is achieved in accordance with the invention by the characteristics given in the description below and in the appended claims.

A cutting machine of a type that is known per se is equipped with a cutting head designed to be able to change the direction of the tip in a very short time. The tip of the cutting head is controlled during the change in direction of the tip, so as to keep it at a constant distance from a fixed point on the axis of the cutting head.

The construction and operation of the cutting head is explained in greater detail in the specific part of the specification with reference to the appended drawings.

The following describes a non-limiting example of a preferred embodiment illustrated in the accompanying drawings, in which:

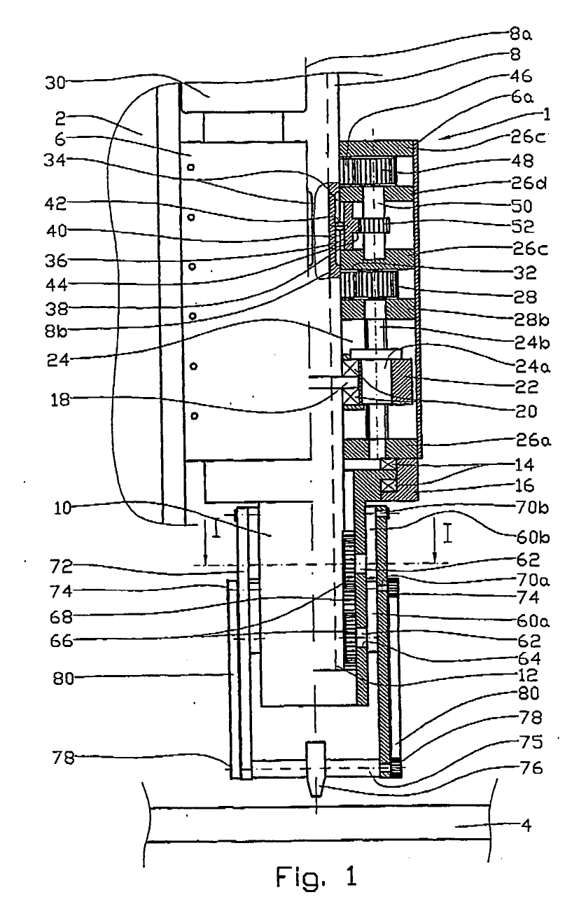

FIG. 1 is a side view, partly in section, of a cutting head;

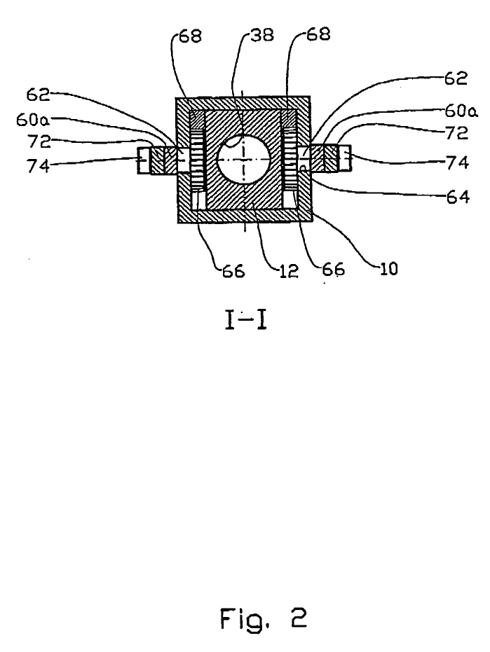

FIG. 2 shows a section I-I in FIG. 1;

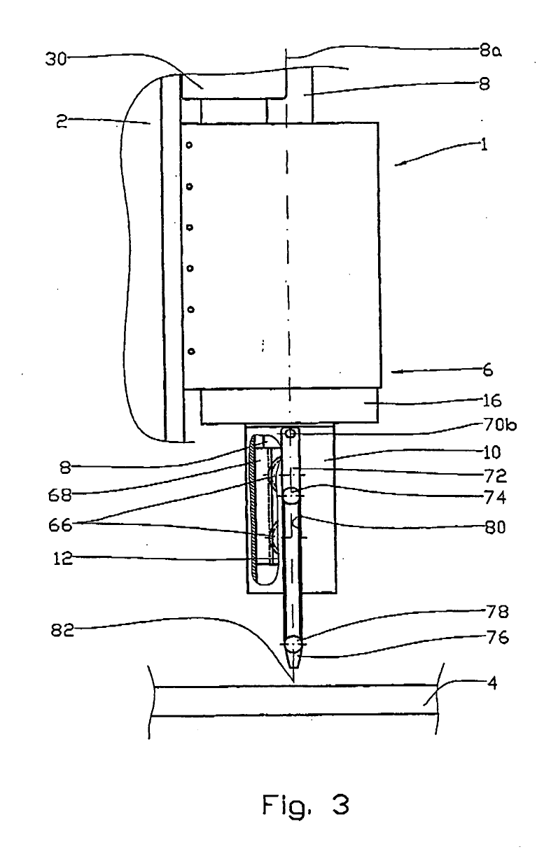

FIG. 3 is a side view in which the spindle of the cutting head has been rotated through 90° relative to FIG. 1, and where the cutting tip is shown in a vertical position;

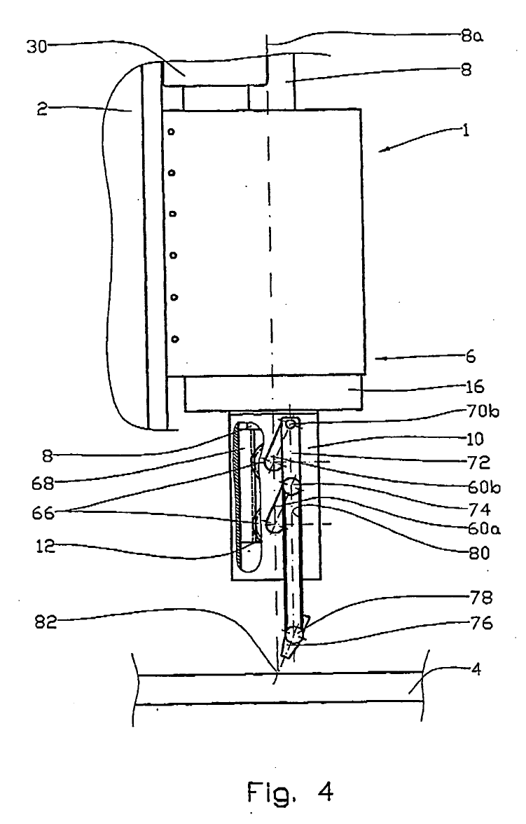

FIG. 4 shows the same as FIG. 3, but here, the cutting tip assumes an angle relative to the vertical axis of the cutting head;

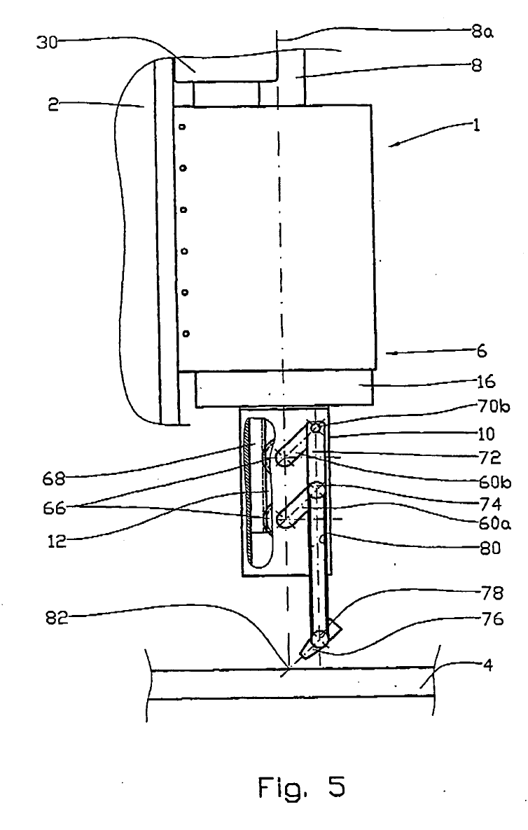

FIG. 5 shows the same as FIG. 3, but here, the cutting tip assumes a greater angle relative to the vertical axis of the cutting head; and

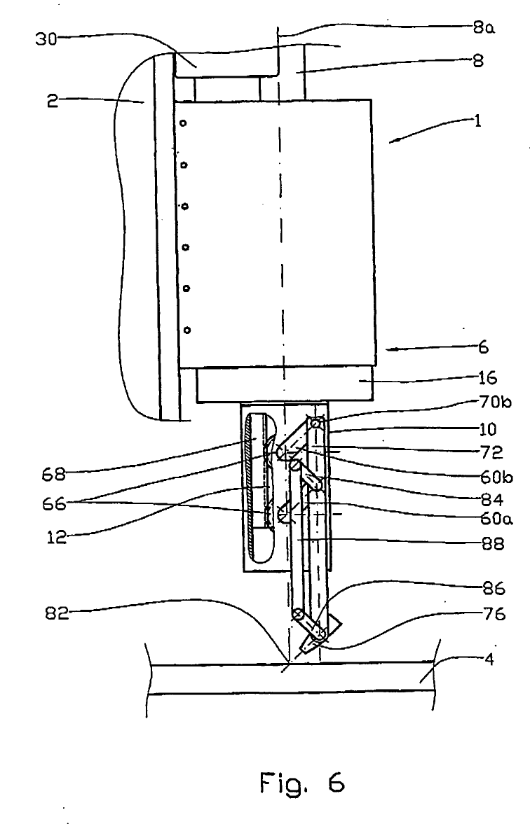

FIG. 6 shows an alternative embodiment in which a belt/chain connection is replaced by crosshead guides.

In the drawings, reference number 1 denotes a cutting head connected to a cutting machine 2, and where a workpiece 4 is placed in a position under the cutting head 1.

The cutting head 1 comprises a casing 6 with a preferably through, axially movable rotatably supported spindle 8 and a rotational sleeve 10 that encloses the lower end portion 12 of the spindle 8 and is rotatably supported on the lower end portion of the casing 6 and bearing housing 16 by means of two ball bearings 14. A cover 6a encloses three of the vertical sides of the casing 6. The spindle 8 is equipped with a through bore 8b and has a cylindrical external cross section at its middle and upper portions, while the lower end portion 12 of the spindle 8 has a rectangular cross section, see FIG. 2. With the exception of a portion by the bearings, the rotational sleeve has a quadratic cross section.

The lower middle portion of the spindle 8 is equipped with a rigidly mounted projecting ring 18 rotatably connected via two thrust bearings 20 to a displacement disc 22. At least two nut/bolt units 24 with longitudinal axes in parallel with the central axis 8a of the spindle 8 are distributed symmetrically along a pitch circle encircling the centre axis 8a. The nut/bolt units 24, preferably of the ball screw type, comprise a nut 24a and a bolt/spindle 24b. The nuts 24a are fixed to the displacement disc 22, while the screw bolts are rotatably supported in the support plates 26a and 26b of the casing 6.

The upper end portion of the bolts 24b are fixed to respective discs/cogwheels 28, which are driven by a lifting motor 30 via transmission element (not shown) and a belt/chain 32.

Around the upper middle portion of the spindle 8, preferably with the same pitch, there is provided a number of axial elongated grooves/cavities 34 with a semicircular-cross section. A rotatable disc 36 is arranged rotatably between the support plates 26c and 26d of the casing 6. The bore 38 of the rotatable disc 36 is provided with longitudinal grooves/cavities 40 with a semicircular cross section that corresponds to the grooves 34 of the spindle 8. At least one ball 42 is arranged in each pair of grooves 34, 40. The rotatable disc 36 is equipped externally with an encompassing cogwheel 44 and is driven by a rotary motor (not shown) via the necessary transmission element (not shown), a belt/chain 46, at least one disc/cogwheel 48 with spindle 50 and cogwheel 52. The spindle(s) 50 is/are rotatably supported in the support plates 26c and 26d of the casing 6.

By each of the two opposite sides of the rotational sleeve 10 there is provided a lower elbow lever 60a and a parallel to the centre axis 8a of the spindle 8 and spaced vertically above the lower elbow lever 60a, upper elbow lever 60b. The lower end portions of the elbow levers 60a and 60b are equipped with a shaft 62 that is rotatably supported in corresponding through bores 64 in the rotational sleeve 10, and which on the inside of the rotational sleeve 10 is mounted to respective cogwheels 66. The cogwheels 66 engage a toothed rack 68 rigidly mounted to its corresponding side of the lower end portion 12 of the spindle 8, see FIG. 2.

On either of the above mentioned opposite sides of the rotational sleeve 10, a shaft 70a is rotationally supported in the middle section of a parallel lever 72 and fixed to the upper end portion of the lower elbow lever 60a. An upper disc/cogwheel 74 is arranged on the outside of the rod and concentrically and rigidly mounted to the shaft 70a. A shaft 70b is rotatably supported in the upper portion of the parallel lever 72 in a through-going manner and rigidly mounted to the upper end portion of the upper elbow lever 60b.

The parallel levers 72 project down from the cutting head 1. By their lower end portions, the parallel levers 72 are rotatably connected to a cutting tip holder 75, where the cutting tip 76 of the cutting head 1 is fastened. The cutting tip holder 75 is equipped with a lower disc/cogwheel 78 arranged concentrically with the rotational axis of the cutting tip holder 75 on the outside of the parallel levers 72. A belt/chain 80 runs between the upper disc/cogwheel 74 and the lower disc/cogwheel 78, the discs/cogwheels 72, 78 being of identical diameter and tooth count.

In FIG. 3, the cutting tip 76 is shown in a vertical position, with the elbow levers 60a and 60b also being arranged in a vertical position when the angle of the cutting tip 76 relative to the vertical axis 8a is to be changed, the lift motor 30 is started up in a first direction of rotation, whereby the spindle 8 is displaced upwards by the belt/chain 32, discs/cogwheels 28, nut/bolt units 24, displacement disc 22 and thrust bearings 20. The toothed racks 68 rigidly mounted to the lower portion 12 of the spindle 8 is thereby displaced upwards, imparting to the cogwheels 66 meshing with the toothed racks 68 a rotation about their own axis. The elbow levers 60a, 60b rigidly mounted to their respective cogwheels 66 via shafts 62 follow the cogwheels 68 through the rotation. Through their cooperative rotation, the lower elbow levers 60a and the upper elbow levers 60b will, through their respective rigidly mounted shafts 70a, 70b rotatably connected to the parallel levers 72, cause the parallel levers 72 to go through a parallel displacement to a new position, see FIG. 4.

The upper disc/cogwheel 74 rigidly mounted to the shaft 70a is, through the rotation of the elbow lever 60a, given a corresponding angular rotation about its own central axis. This angular rotation is transferred via the belt/chain 80 and the lower disc/cogwheel 78 to the cutting tip holder 75 rotatably connected to the parallel levers 72, whereby the cutting tip 76 is given the same angular rotation as the elbow levers 60a, 60b.

The geometrical construction of the cutting head 1 causes the change in angle of the cutting tip 76, which is achieved through a simultaneous lateral displacement and rotation of the cutting tip holder 75, to be performed about a point of intersection/pivot point 82 between the centre line of the cutting tip and the centre line 8a of the spindle B. During the change in angle, the cutting tip 76 remains at an unchanged distance from the pivot point 82.

By arranging the workpiece 4 at an appropriate height relative to the pivot point 82, the angle of the cutting tip 76 may be changed without the cutting line of the cutting tip 76 at a predetermined level, such as the surface of the workpiece 4, being displaced laterally. Thus it is not necessary to move the workpiece 4, which may be of a considerable mass, laterally in relation to the direction of cutting, even when the angle of the cutting tip 76 has to be changed. In FIG. 5, the angle of the cutting tip 76 relative to the axis 8a has been increased further relative to the angle shown in FIG. 4.

The spindle 8, and thereby the cutting tip 76, is rotated about the spindle axis 8a by the rotary motor (not shown) being started up, and rotates via the belt/chain 46, the disc(s)/cogwheel(s) 48, the spindle(s) 50, the cogwheel(s) 52, the enclosing cogwheel 44 and the rotatable disc 36 via the balls 42 and the spindle 8 to the desired angle of rotation.

The direction of the cutting tip 76 during rotation about the vertical axis 8a and during changes in angle in the vertical plane relative to said axis 8a will always face the pivot point 82.

In an alternative embodiment, see FIG. 6, the discs 74, 78 and belts/chains 80 have been replaced by a first lever 84 and a second lever 86 hinged to a rod 88. The action of the levers 84, 86 and the rod 88 is the same as the action of the belts/chains 80 as described above.

The twisting of the shafts 62 may also be effected through the use of other transmission elements such as a worm screw with corresponding worm wheel.

Using the cutting head 1 according to the invention allows rapid changes in the angle of cutting both in the horizontal is and vertical planes to be carried out in a very short time without requiring the activation of large inertia forces. As an example, this makes it possible to maintain a constant cutting angle relative to the workpiece also during relatively quick changes in the direction of cutting at a high feed rate. The changes in angle are controlled by a pre-programmed computer.

1. A cutting/milling head device (1) of the type connected to a cutting machine/milling machine (2), and where the cutting/milling head (1) is designed, when in operation, to be able to change the angle of a cutting tip/the mill (76) relative to a central axis (8a) while at the same time rotating the cutting tip/mill (76) about the same central axis (8a), characterised in that at least at least two shafts (62) rotatably mounted to a rotational sleeve (10) are connected to their respective, mutually parallel lower elbow lever (60a) and upper elbow lever (60b), the elbow levers (60a, 60b) at opposite end portions being hinged to a parallel lever (72), and where the lower end portion of parallel lever (72) is hinged to a cutting tip holder (75), the hinge joints of the parallel lever (72) to the elbow levers (60a, 60b) and the cutting tip holder (75) having parallel axes;
a first disc/cog wheel (74) is rigidly mounted via a shaft (70a) to the lower elbow lever (60a), where the shaft (70a) constitutes the hinge joint to the parallel lever (72), and a second disc/cog wheel (78) is rigidly mounted to the cutting tip holder (75) at the hinge joint to the lower portion of the parallel lever (72), the two discs/cog wheels being interconnected by means of a belt/chain (80), whereby the cutting head (1) is designed so that the direction of cutting of the cutting htip always faces a pivot point (82).

2. Device in accordance with claim 1, characterized in that at least two shafts (62) rotatably mounted to rotational sleeve (10) are connected to their respective, mutually parallel lower elbow lever (60a) and upper elbow lever (60b), the elbow levers (60a, 60b) at opposite end portions of being hinged to a parallel lever (72), and where the lower end portion of the parallel lever (72)is hinged to a cutting tip holder (75) having parallel axes;
a first lever (84) is rigidly mounted to via a shaft (70a) to the lower elbow lever (60a), where the shaft (70a) constituters the hinge joint to the parallel lever (72), and a second lever (86) is rigidly mounted to the cutting tip holder (75) at the hinge joint to the lower portion of the parallel lever (72), the facing end portions of the two levers being interconnected in an articulated manner by means of a rod (86).

3. A device in accordance with claim 1, characterised in that an axially movable spindle (8) is equipped with at least one tooth rack (68) in engagement with at least two cogwheels (66), where the cogwheels (66) are rigidly mounted to their respective shafts (62).

4. A device in accordance with claim 1, characterised in that the rotational sleeve (10) that forms a bearing housing for the shafts (62) of the elbow levers (60a, 60b) is rotatable about the axis (8a) of the spindle (8) connected to the casing (6) of the cutting head (1).

5. A device in accordance with claim 1, characterised in that the spindle (8) is supportingly connected to a displacement disc (22), where the displacement disc (22) is connected to the nut part (24a) of at least one nut/bolt connection (24) parallel to the spindle (8), and where the bolt part (24b) of the nut/bolt connection (24) is rotatably supported in the casing (6) of the cutting head (1).

6. A device in accordance with claim 1, characterised in that the spindle (8) is equipped with at least one elongated cavity (34) corresponding to an elongated cavity (40) in the bore (38) of a rotatable disc (36), where a ball (42) is arranged partly In the cavity (34) of the spindle (8), partly in the cavity (40) of the rotatable disc (36).
